(19) United States
(12) Patent Application Publication
(10) Pub. No.: US 2018/0264591 A1
(43) Pub. Date: Sep. 20, 2018

(54) METHOD FOR GUIDING A MACHINING HEAD ALONG A TRACK TO BE MACHINED

(71) Applicant: PRECITEC GMBH & CO. KG, Gaggenau-Bad Rotenfels (DE)

(72) Inventors: Fabian Agrawal, Gernsbach (DE); Stefan Birmanns, Buch am Irchel (CH); Joachim Schwarz, Kleinandelfingen (CH); Eric Supernok, Edesheim (DE)

(21) Appl. No.: 15/761,079

(22) PCT Filed: Sep. 16, 2016
(86) PCT No.: PCT/EP2016/071938

§ 371 Date: Mar. 16, 2018

(30) Foreign Application Priority Data
Sep. 18, 2015 (DE) 10 2015 115 803.5

(51) Int. Cl. B23K 26/044; B23K 26/04; B23K 26/26; B23K 26/28

(52) U.S. Cl. CPC B23K 26/044; B23K 26/28; B23K 26/26; B23K 26/048

(57) ABSTRACT

The invention relates to a method for guiding a machining head, in particular a laser machining head (10), along a track (23) to be machined, in which a line of light (16) is projected onto the track (23) to be machined, transversely with respect to the latter, at a distance (d) in front of the machining point (14) in the machining direction, in which, from images of the line of light (16) recorded continuously during the machining, the position y(Pn) of the track (23) in front of the machining point (14) is determined, and in which the machining point (14) is aligned with the track (23) as soon as the machining point (14) reaches the respective point (Pn) on the track (23) for which the position y(Pn) of the track (23) was determined. In order to guide the machining point (14), that is to say in particular the focus of a machining laser beam, precisely along the track (23) to be machined, that is to say along a seam or joint to be joined, provision is made for the current machining speed at which the machining point (14) is guided along the track (23) to be machined to be measured, and that, from the distance (d) of the line of light (16) from the machining point (14) and the current machining speed, the time at which the machining point reaches the respective point (Pn) of the track (23) is determined.

The invention relates to a method for guiding a machining head, in particular a laser machining head, along a track to be machined, in particular along a joint or a butt joint between two parts to be joined that are to be welded to one another.

When welding with laser radiation, the laser beam must be directed such that its focus, forming the machining point, impinges exactly on the joint or the butt joint of the parts to be joined that are to be welded to one another. Used for this purpose are seam tracking systems, which with the aid of triangulation sensors record the actual position of the seam or butt joint, that is to say of the track to be machined. In the case of these systems, the distance of a line of light projected onto the workpiece before the point of impingement of the laser beam from the point of impingement of the laser beam and the rate of advancement of the laser point of impingement, that is to say the machining point, are prescribed as parameters.

A disadvantage of this procedure is that, especially in the case of kinematic systems, in which the rate of advancement changes during the welding operation, which is the case in particular with robot-guided laser machining heads, the actual position deviates from the setpoint position of the laser point of impingement. The reason for this is that the time, calculated from the rate of advancement and the distance, for the tracking of the laser point of impingement, that is to say of the machining point generated by the laser beam, is incorrectly calculated if the rate of advancement is changed. Especially in the case of small diameters in the laser beam focus, the accuracy with which the laser beam impinges on the track to be machined, that is to say the joint or the butt joint, is a relevant variable for the attachment cross section and consequently for the quality of the welded connection. The smaller the laser beam diameter, the more exactly the laser beam must impinge on the joint.

Furthermore, errors may arise as a result of the distance from the workpiece surface to the focal position changing. As a result, the distance of a line of light projected onto the workpiece from the point of impingement of the laser on the workpiece surface also changes. In order in the case of this error to shift the focus of the laser beam back to the workpiece surface, the distance of a beam-shaping optical unit from the workpiece surface may be corrected. For this purpose, for example, the beam-shaping optical unit in the laser machining head may be adjusted. It is however also possible in principle to adjust the laser machining head perpendicularly with respect to the workpiece surface.

DE 10 2010 060 162 B3 discloses a method for increasing the accuracy of the guidance of the machining laser of joining devices by the light section or triangulation method, in which the distance of a measuring line of light ahead of a point of impingement of a machining laser from the point of impingement is varied in the longitudinal direction of the seam, in order to determine from the image data thereby obtained the topology of the workpiece with the aid of the light section method. On the basis of the knowledge of the topology of the workpiece, it is possible to compensate for an error of the distance between the measuring line of light and the laser machining point that is caused by a change in height.

DE 10 2006 004 919 A1 discloses a further method for guiding a laser machining head along a seam to be welded by means of a light section method in which, in advance in the welding direction, a laser line is projected onto the seam to be welded and is measured by an image processing unit. From the image of the laser line, the profile of the seam to be welded is determined, and consequently its actual position. The measured deviation of the current position of the seam to be welded from a setpoint position is taken as a basis for determining a correction signal, which is used directly, without taking into account the distance of the measuring position from the welding position, that is to say from the machining point, to guide the laser focus determining the welding position along the seam to be welded.

DE 10 2006 030 130 B3 discloses an adaptive laser machining head which is provided with one or more optical sensors for measuring the distance of the laser machining head from the workpiece and for measuring the velocity vector of the laser machining point in the plane perpendicular to the direction of the distance, that is to say in the plane corresponding to the surface of the workpiece. On account of the optical sensors used and the processing of the measurement data determined, it is possible to guide the laser machining point along a track to be machined. In this case it is possible to carry out closed-loop control on the basis of the rate of advancement of the laser machining point in dependence on the distance of the working point from the workpiece surface and/or on the direction in which the laser beam is beamed in.

DE 10 2009 057 209 discloses a further laser machining head, which is equipped with a scanner optical unit for the working laser beam, with the aid of which, in addition to seam guidance, the machining speed, that is to say the speed with which the laser machining point is moved in relation to the workpiece, can be reduced or increased in relation to the guiding speed, that is to say in relation to the speed of the laser machining head. The seam tracking itself, that is to say the guidance of the laser machining point along the seam or track to be machined, takes place once again on the basis of the light section principle by means of triangulation.

DE 10 2010 011 253 A1 discloses a further method for guiding a laser machining head along a track to be machined in which the position of a seam or track to be joined is recorded on the basis of the light section principle with the aid of a line of light projected onto the machining line ahead of the machining point. Since, for an optimum joining process, the machining point, that is to say the focus of the working laser beam, is intended always to run at a predetermined height along the seam to be joined, the distance of the line of light from the point of impingement of the laser beam is also evaluated. In dependence on the recorded distance, the laser machining head is moved up and down perpendicularly with respect to the surface of a workpiece to be machined, in order to keep the distance of the line of light from the machining point constant, whereby the distance between the laser machining head and the workpiece, and consequently the position of the focus of the working laser beam in relation to the workpiece, is also kept constant.

Against this background, the invention is based on the object of providing a further method for guiding a machining head, in particular a laser machining head, along a track to be machined with which the machining point, that is to say in particular the focus of a machining laser beam, is guided precisely along the track to be machined, that is to say along a seam or joint to be joined.

This object is achieved by the method according to claim 1. Advantageous refinements and developments of the invention are described in the subclaims.

According to the invention, the machining point is not set in the standard way after a prescribed delay time after the recording of the position of a track to this position, but instead the delay time is in each case determined individually during the machining for each machining point or for a successive group of machining points from the respective actual machining speed and the respective actual distance of a light section line from the machining center point (TCP, Tool Center Point). This achieves the effect that the adjustment of the machining point always takes place exactly at the time at which the machining point is at the location of the track to the position of which the machining point is to be set. This allows setting inaccuracies that could considerably impair the quality of the machining to be ruled out almost completely.

Although it is possible in principle to measure the current machining speed, that is to say the actual machining speed, by means of suitable methods, it is provided according to the invention that the current machining speed is read from a control unit controlling the movement of the machining head and used as a current parameter for the calculation of the time for the tracking of the machining point.

In the case of an advantageous refinement of the invention, it is also provided that the actual distance between the line of light on the workpiece and the machining point in the machining direction is recorded and used as a current parameter for the calculation of the time for the tracking of the machining point. As a result, the precision of the tracking of the machining point is improved further.

Since it is necessary when machining a workpiece by means of laser radiation, in particular when welding, always to keep the focus of a machining laser beam at the same distance from a workpiece surface, it is provided in the case of an advantageous refinement of the invention that the recorded actual distance between the line of light and the machining point is used as a parameter of a closed-loop control of the distance of the focus of a machining laser beam from a workpiece surface.

The closed-loop control of the distance of the focus of the machining laser beam can in this case take place either by displacement of the entire laser machining head or by displacement of a beam-shaping optical unit within the laser machining head.

The invention is explained in more detail below for example on the basis of the drawing, in which:

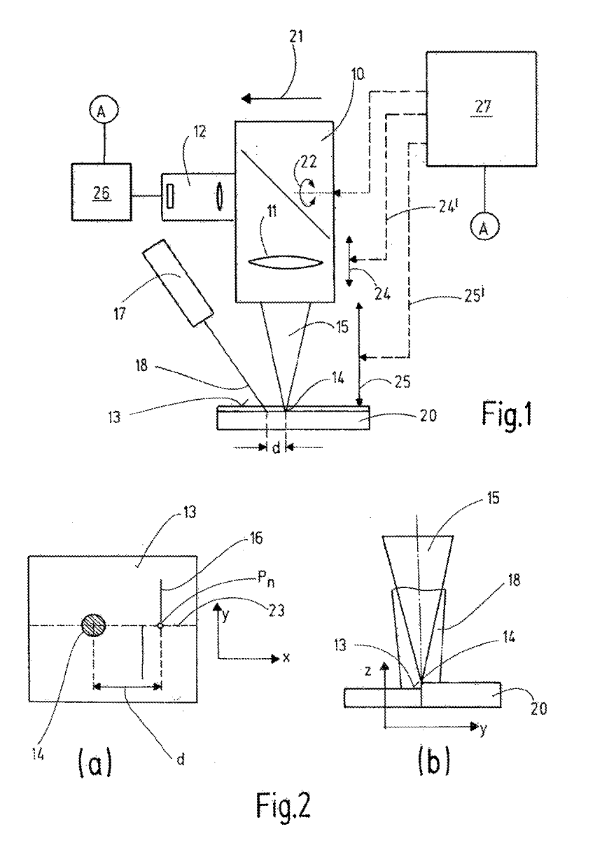

FIG. 1 shows a simplified schematic block diagram of a machining head, in particular a laser machining head, with a seam tracking system,

FIG. 2 (a) shows a schematic representation of a camera image of a workpiece surface in the region of a laser point of impingement and a light section line, and

FIG. 2 (b) shows a schematic simplified sectional representation of a workpiece transversely with respect to the machining track with a machining laser beam and fans of light for generating the light section line.

In the various figures of the drawing, elements that correspond to one another are provided with the same designations.

FIG. 1 shows in a greatly simplified form a machining head, in particular a laser machining head 10, with a beam-shaping optical unit 11 and a camera 12 for observing a workpiece surface 13 in the region of a point of impingement 14 of a machining laser beam 15, also referred to hereinafter simply as laser beam 15, and a light line 16, which is projected from a light section projector 17 by means of a fan of light 18 onto the surface 19 of a workpiece 20.

The laser machining head 10 is guided by a machine control, which is not represented any more specifically, in the direction of advancement 21 at a speed corresponding to the machining process. As indicated by the double-headed arrow 22, the laser machining head 10 can be pivoted or else displaced laterally, in order to keep the point of impingement 14 of the laser beam exactly on the track 23 to be machined, that is to say on the butt joint between two parts of a workpiece. Furthermore, the machine control serves for adjusting the beam-shaping optical unit 11, in particular the focusing optical unit within the laser machining head 10, as is indicated by the double-headed arrow 24. Furthermore, the entire laser machining head 10 can also be adjusted according to the double-headed arrow 25 perpendicularly with respect to the workpiece surface 19, in order to set the height position of the laser focus in relation to the workpiece 20.

From the image data recorded by the camera 12, an image processing unit 26 determines a distance d between the light line 16 and the point of impingement 14 of the laser beam 15 and also the position of the point of intersection Pn between the light line 16 and the butt joint or track 23 in the y direction, that is to say in the direction transverse to the direction of advancement of the laser machining point 10, that is to say transverse to an x direction.

To guide the point of impingement 14 of the machining laser beam 15 precisely on the track 23 to be machined, that is to say on the recorded butt joint, it is necessary to determine the time after which the point of impingement 14 of the laser beam 15 is set to the recorded position of the track.

This time is calculated as the quotient of the distance d divided by the current rate of advancement or machining speed.

Although it is possible in principle to measure the current rate of advancement, it is expedient if a calculating unit 27, which is fed not only the position y(Pn) determined from the camera image but also the distance d between the point of impingement 14 of the laser beam 15 and the light line 16, reads the current machining speed from a control unit of the machine control.

The distance d between the light line 16 and the point of impingement 14 of the laser beam 15, determined by the image processing unit 26, is used not only as a parameter for calculating the time difference between recording the position y(Pn) of the track and the tracking of the point of impingement 14 of the laser beam 15, but also as a parameter for setting the height of the laser beam focus in relation to the surface 13 of the workpiece 20. By means of triangulation, it is possible to determine from the comparison of the actual distance with a setpoint distance the position of the laser beam focus in relation to the workpiece surface 13 in the z direction, that is to say perpendicular to the workpiece surface 13. If the actual distance d is less than the setpoint distance, the working laser focus, which corresponds to the laser machining point, that is to say the TCP, is located at a distance above the workpiece surface 13. Conversely, if the actual distance is greater than the setpoint distance, the laser beam focus lies below the workpiece surface 13.

To move the laser beam focus into the desired position perpendicularly with respect to the workpiece surface, it is on the one hand possible to output a corresponding actuating signal to the machine control, which adjusts the entire laser machining head 10 in a way corresponding to the double-headed arrow 25, as indicated by the dashed line 25′. However, the laser beam focus can also be adjusted by displacing or changing the beam-shaping optical unit 11 in response to a corresponding actuating signal, as indicated by the dashed line 24′.

To ensure the quality of a laser machining, in particular a welding process, precise seam tracking is required. For this purpose, according to the invention the actual rate of advancement during the machining process, that is to say in particular during the welding process, is read from the machine control and used by the software of a calculating unit 27 as a current parameter for the calculation of the time for the tracking of the laser point of impingement 14. On the basis of triangulation, the displacement of the laser beam focus in the radiating direction (z direction) is calculated from the change in the distance of the light line 16 from the laser point of impingement 14, that is to say from the change in the distance of the light section to the TCP, likewise determined by the image processing unit 26. This value is then used to displace the focusing or collimating lens in such a way that the laser beam focus again lies on the workpiece surface 13.

To obtain precise seam tracking, therefore, according to the invention both the rate of advancement, changing over time, of the laser machining head in relation to the workpiece and the changes of the distance of a light section line from the machining center point, that is to say from the laser point of impingement, are taken into account. Both values are computationally taken into account in the focus tracking for the lateral seam tracking of the machining line.

1. A method for guiding a laser machining head, along a track to be machined, in which
a line of light is projected onto the track to be machined, transversely with respect to the latter, at a distance in front of the machining point in the machining direction,
the position of the track in front of the machining point is determined from images of the line of light recorded continuously during the machining, and
the machining point is aligned with the track as soon as the machining point reaches the respective point on the track for which the position of the track was determined,
wherein the current machining speed at which the machining point is guided along the track to be machined is read from a control unit controlling the movement of the machining head, and
wherein the time for the tracking of the machining point at which the machining point reaches the respective point of the track is determined from the distance of the line of light from the machining point and the current machining speed.

2. The method as claimed in claim 1, wherein the actual distance between the line of light on the workpiece and the machining point in the machining direction is recorded and used as a parameter for the calculation of the time for the tracking of the machining point.

3. (canceled)

4. The method as claimed in claim 2, wherein the recorded actual distance is used as a parameter of a closed-loop control of the distance of the focus of a machining laser beam from a workpiece surface.

5. The method as claimed in claim 4, characterized in that wherein the recorded actual distance is used as a parameter in a closed-loop control of a distance of the machining head from the workpiece surface.

6. The method as claimed in claim 4, the wherein recorded actual distance is used as a parameter for displacing a beam-shaping optical unit for focusing the machining laser beam onto the workpiece surface.
